(19) United States
(12) Patent Application Publication
(10) Pub. No.: US 2023/0334903 A1
(43) Pub. Date: Oct. 19, 2023

(54) Techniques and Apparatuses that Implement Camera Manager Systems Capable of Generating Frame Suggestions from a Set of Frames

(71) Applicant: Google LLC, Mountain View, CA (US)

(72) Inventors: Lin Chen, Mountain View, CA (US); Wei Hong, Sunnyvale, CA (US)

(21) Appl. No.: 18/029,510

(22) PCT Filed: Oct. 1, 2020
(86) PCT No.: PCT/US2020/053704

§ 371 Date: Mar. 30, 2023

(51) Int. Cl. G06V 40/16; G06T 7/00; G06T 5/20; G06V 10/44; G06V 10/74

(52) U.S. Cl. CPC G06V 40/171; G06T 5/20; G06T 7/0002; G06V 10/44; G06V 10/761; G06T 2207/30168

(57) ABSTRACT

Techniques and apparatuses are described that implement a camera manager system capable of generating frame suggestions from a set of frames. The camera manager system (120) utilizes at least one of a face diversity scorer (406) and an aesthetic diversity scorer (408), in conjunction with a time diversity scorer (404), to select and suggest diverse frames from a set of frames (304). In this way, the camera manager system (120) enables a computing device (102) to provide a user (10) of the computing device with a better selection of suggested frames. Through the better selection of suggested frames, the computing device (102) can improve the quality of the user’s experience in using the computing device and/or a camera application of the computing device. The better selection of suggested frames further decreases wasted resources (e.g, similar image storage, processor usage to process the capture of additional frames, battery usage associated with capturing additional frames, and the like).

### BACKGROUND

Computing devices that include an image-capture application (e.g., smartphones) often include an element that acquires and suggests one or more frames captured by the device after a user presses a physical button or a shutter button on a graphical user interface (GUI) of the device. Current frame-suggestion techniques select frames based on frame-quality metrics, oftentimes resulting in the computing device suggesting a number of visually similar frames to the user. The presentation of such visually similar frames is of limited use to the user and can reduce the user experience associated with the use of the frame-suggestion techniques.

### SUMMARY

This document describes techniques and apparatuses that implement a camera manager system capable of generating frame suggestions from a set of frames (e.g., images, photos, photographs, videos). In an aspect, a camera manager system utilizes at least one of a face diversity scorer and an aesthetic diversity scorer, in conjunction with a time diversity scorer, to select and suggest diverse frames from a set of frames. By doing so, the camera manager system conserves power, improves accuracy, and/or reduces latency relative to many common techniques and apparatuses for frame suggestion. The camera manager system further provides for a better user experience.

A method is described in this document that includes receiving a stream of image data defining a first frame and a set of frames not including the first frame, then performing a frame score generation process to calculate a frame diversity score. The frame score generation process includes calculating a time diversity score for the frames of the set of frames relative to the first frame, calculating a facial diversity score for the frames of the set of frames relative to the first frame, and calculating an aesthetic diversity score for the frames of the set of frames relative to the first frame. A frame diversity score for the frames of the set of frames relative to the first frame is calculated based on the facial diversity score, the aesthetic diversity score, and the time diversity score. The frame score generation process further includes determining, using the frame diversity score, whether to include the first frame as part of an image object representing suggested frames of the stream of image data. Such a method may exhibit improved power conservation, improved accuracy, and/or reduce latency relative to many common techniques and apparatuses for frame suggestion. The camera manager system further provides for a better user experience.

This document also describes computer-readable storage media having instructions for performing the above-summarized method and other methods set forth herein, as well as apparatuses and means for performing these methods.

This Summary is provided to introduce simplified concepts for techniques and apparatuses that implement a camera manager system capable of generating frame suggestions from a set of frames, which are further described below in the Detailed Description and Drawings. This Summary is not intended to identify essential features of the claimed subject matter, nor is it intended for use in determining the scope of the claimed subject matter.

### BRIEF DESCRIPTION OF THE DRAWINGS

The details of one or more aspects of techniques and apparatuses that implement a camera manager system capable of generating frame suggestions from a set of frames are described in this document with reference to the following drawings. The same numbers are used throughout the drawings to reference like features and components:

FIG. 1 is a schematic diagram illustrating an example environment in which techniques that implement a camera manager system capable of generating frame suggestions from a set of frames can be implemented;

FIG. 2 is a schematic diagram illustrating an example implementation of a computing device, including a camera manager system capable of generating frame suggestions from a set of frames;

FIG. 3 is a block diagram illustrating how camera manager system components may be integrated with or within a camera application of a computing device, according to an example implementation;

FIG. 4 is a block diagram illustrating feature scoring module components of a camera manager system, according to an example implementation;

FIG. 5 depicts an example method implementing a camera manager system capable of generating frame suggestions from a set of frames;

FIG. 6 depicts another example method enabling a camera manager system capable of generating frame suggestions from a set of frames; and

FIG. 7 illustrates various components of an example computing device that can be implemented as any type of client, server, and/or electronic device as described with reference to FIGS. 1-6 to implement, or in which techniques may be implemented that enable, a camera manager system capable of generating frame suggestions from a set of frames.

### DETAILED DESCRIPTION

### Overview

This document describes aspects of techniques and apparatuses that implement a camera manager system capable of generating frame suggestions from a set of frames (e.g., images, photos, photographs, videos). The camera manager system may utilize at least one of a face diversity scorer and an aesthetic diversity scorer, in conjunction with a time diversity scorer, to select and suggest diverse frames from a set of frames. In this way, the camera manager system enables a computing device to provide a user of the computing device with a better selection of suggested frames. The better selection of suggested frames further decreases wasted resources (e.g., similar image storage, processor usage to processing the capture of additional frames, battery usage associated with capturing additional frames, and the like). Through the better selection of suggested frames, the camera manager system can improve the quality of the user’s experience in using the computing device and/or a camera application of the computing device.

In an example use, assume that a user uses a camera application on their smartphone to take a number of photographs (frames) of a scene, for example, a group of the user’s friends posing in front of an architectural work. The user may trigger the camera application to capture the frames by pressing a shutter button (e.g., a physical button, a user interface button). When the user reviews the captured frames, the user discovers that the eyes of one of the user’s friends were closed when the frame was captured, rendering the frame unsatisfactory to the user and/or requiring the user to retake the frame.

In addition to capturing frames relating to the instant the user pressed the shutter button, the camera application may also capture a number of additional frames before and/or after the shutter button was pressed. The smartphone can then present to the user a diverse selection of frames, namely, the captured frames and the additional frames, when the user reviews the frames captured. By presenting the user with a diverse selection of frames taken before and after the shutter button was pressed, the likelihood of capturing acceptable images increases. Oftentimes, in presenting a selection of time diverse frames to a user, the user is unable to determine whether a given frame is better or worse than another frame, including the frames that were captured when the shutter button was pressed. This can result in wasted resources of the smartphone, for example the storage of too many similar images, excessive processor usage for processing the capture of additional frames, excessive battery usage associated with capturing additional frames, and the like. It can result in a less than optimal user experience. Such wastage of resources can be of concern in computing devices such as smartphones where data storage and battery size may be limited by the size of the smartphone.

In contrast, consider the disclosed techniques and apparatuses, which implement a camera manager system capable of generating frame suggestions from a set of frames. In aspects, the camera manager system utilizes one or more diversity scorers (e.g., a face diversity scorer, an aesthetic diversity scorer, a time diversity scorer) in a frame-suggestion process. Utilizing the diversity scorers, the camera manager system determines a more diverse selection of frames for presentation to the user so that the suggested frames are visually different, thereby decreasing wasted resources (e.g., similar image storage, processor usage for processing the capture of additional frames, battery usage associated with capturing additional frames, and the like), and increasing the quality of the user experience. Providing the more diverse selection of frames may allow the user to analyze the selection of frames more rapidly and/or efficiently, thereby assisting the user in an image analysis or image classification task, for example. The user may need to use the computing device for a shorter period of time, reducing battery and processor usage of the computing device. The user may avoid having to capture additional frames, again reducing battery and processor usage of the computing device.

This is but one example of how the described techniques and apparatuses that implement a camera manager system capable of generating frame suggestions from a set of frames may be used to determine a more-diverse selection of frames for presentation to the user. Other examples and implementations are described throughout this document. The document now turns to an example operating environment, after which example devices, methods, and systems are described.

### Operating Environment

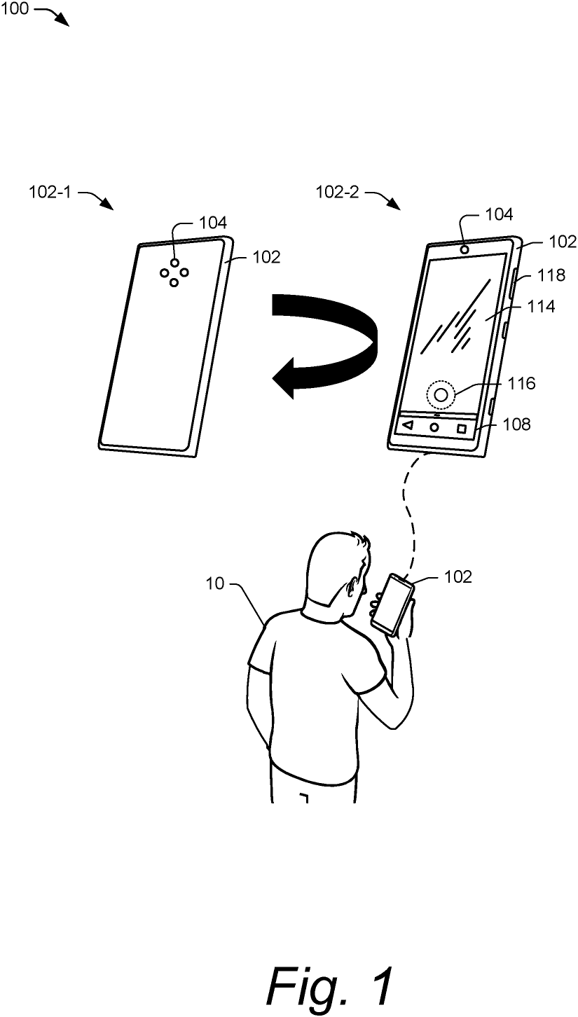

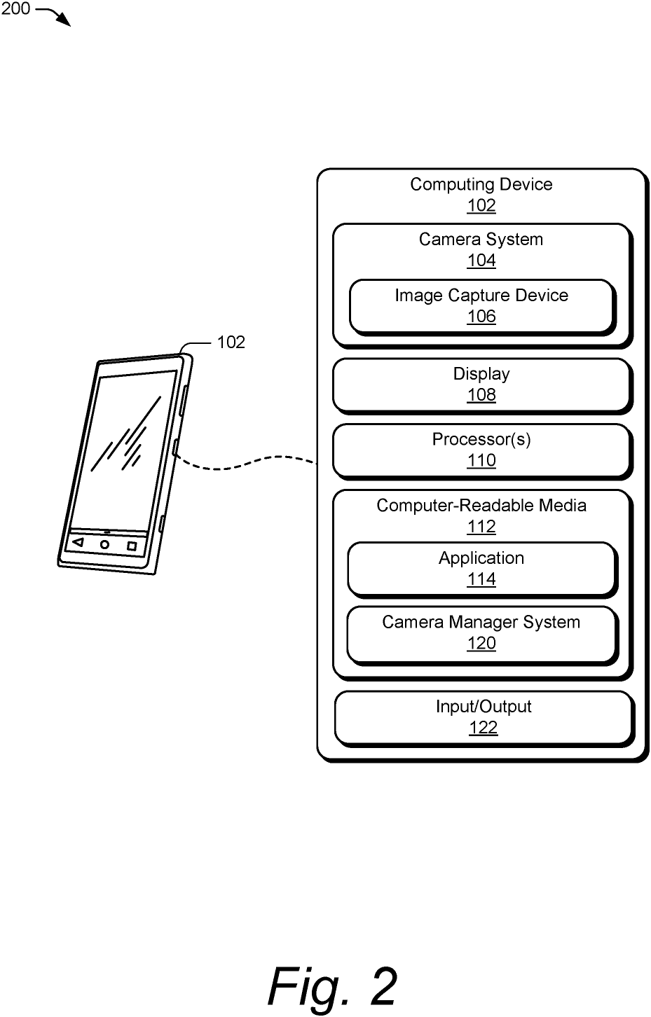

FIG. 1 illustrates an example environment 100 in which techniques that implement a camera manager system capable of generating frame suggestions from a set of frames may be utilized. The example environment 100 includes an example implementation of a computing device 102 that can perform techniques that implement a camera manager system capable of generating frame suggestions from a set of frames. In FIG. 1, a user 10 is illustrated holding and operating the computing device 102, for example, to capture an image utilizing a camera application. Both a rear view 102-1 and a front view 102-2 of the computing device 102 are illustrated. While the computing device 102 of FIG. 1 is illustrated as a smartphone, in other aspects, the computing device may be another type of computing device (e.g., tablet, laptop, camera, desktop computer, computing watch, gaming system, computing spectacles, home-automation and control system, smart appliance, automobile, television, entertainment system, audio system, drone, track pad, drawing pad, netbook, e-reader, home security system, and the like). Note that, in aspects, the computing device 102 can be wearable, non-wearable but mobile, or relatively immobile (e.g., desktops and appliances). FIG. 2 further illustrates the computing device 102 of FIG. 1.

The computing device 102 includes, or is associated with, a camera system 104 including at least one image capture device 106 (e.g., a camera), at least one display 108 (e.g., display screen, display device), one or more computer processors 110 (processor(s) 110), and a computer-readable media 112 (CRM 112). The computing device 102 may be in communication with the image capture device 106 for capturing images and/or video. As illustrated in FIG. 1, the computing device 102 may include at least one built-in or internal image capture device 106 (e.g., camera, charge-coupled device (CCD)). In another example implementation (not illustrated), the image capture device 106 may be external to the computing device 102 and in communication with the computing device, for example, through a direct connection or wireless coupling.

The display 108 can include any suitable display device (e.g., a touchscreen, a liquid crystal display (LCD), thin film transistor (TFT) LCD, an in-place switching (IPS) LCD, a capacitive touchscreen display, an organic light-emitting diode (OLED) display, an active-matrix organic light-emitting diode (AMOLED) display, super AMOLED display). The display 108 may be combined with a presence-sensitive input device to form a touch-sensitive or presence-sensitive display for receiving user input from a stylus, finger, or other means of gesture input. The display 108 may display graphical images and/or instructions provided by the computing device 102 and may aid a user in interacting with the computing device 102. The display 108 can be separated from the camera system 104 (as illustrated in FIG. 1 and FIG. 2) or can be part of the camera system 104 (not illustrated as such).

The display 108 presents a GUI of an application 114 (e.g., a camera application 114). The GUI of the application 114 may include one or more input controls (e.g., GUI shutter button 116) for providing input to the computing device 102, e.g., for triggering capture of an image. Accordingly, the application 114 may receive user input through the presence-sensitive display 108, for example, an activation of the shutter button 116. The computing device 102 may also include input/output (I/O) devices 122, for example, one or more physical buttons 118 (illustrated in FIG. 1). The I/O devices 122 for providing input to the computing device 102 (e.g., for triggering the capture of an image). The application 114 may be embodied in one or more of software, applet, firmware, peripheral, hardware, or another entity configured to operate an image capture device 106. In an example, the application is a camera application 114 installed on the computing device 102. In another example, the application is part of an operating system (OS) that enables camera functionality in applications.

The CRM 112 may include any suitable memory or storage device, including random-access memory (RAM), static RAM (SRAM), dynamic RAM (DRAM), non-volatile RAM (NVRAM), read-only memory (ROM), or flash memory. The CRM 112 may include a memory system. The CRM 112 includes device data. The device data may include user data, multimedia data, a ring buffer, a candidate buffer, a feature store, application(s) 114, a camera manager system (camera manager 120), a feature extraction module, a feature scoring module, a frame selection module, a machine-learned model (e.g., a score model), and/or an operating system (not illustrated) of the computing device 102, which are implemented as computer-readable instructions on the CRM 112 that are executable by the processor(s) 110 to provide some or all of the functionalities described herein. For example, the processor(s) 110 can be used to execute instructions on the CRM 112 to implement the disclosed techniques and apparatuses that implement a camera manager system 120 (camera manager 120) capable of generating frame suggestions from a set of frames.

The device data may include executable instructions of a camera manager 120 that can be executed by the processor(s) 110. The camera manager 120 represents functionality that causes the computing device 102 to perform operations described within this document to generate frame suggestions from a set of frames captured by the camera system 104. The operations may include receiving input from a user, for example, the user providing input by pressing a physical button 118 or by pressing a shutter button 116 on a GUI of an application 114. The device data may further include executable instructions of one or more modules (e.g., a feature extraction module, a frame selection module, a result generator module) that can be executed by the processor(s) 110 to implement a camera manager system.

Various implementations of the disclosed systems and apparatuses that implement a camera manager system capable of generating frame suggestions from a set of frames can include a System-on-Chip (SoC), one or more Integrated Circuits (ICs), a processor with embedded processor instructions or configured to access processor instructions stored in memory, hardware with embedded firmware, a printed circuit board with various hardware components, or any combination thereof.

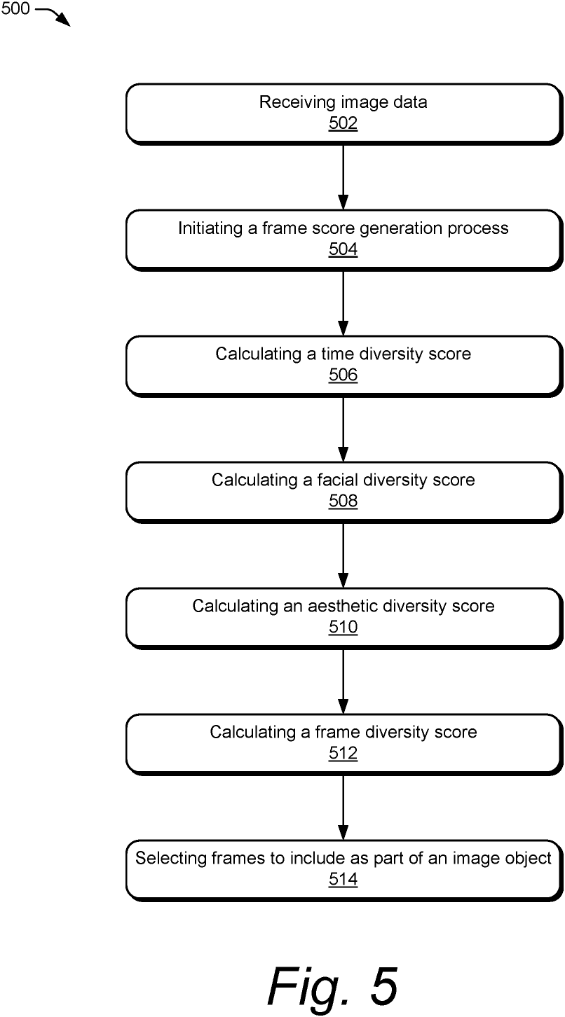

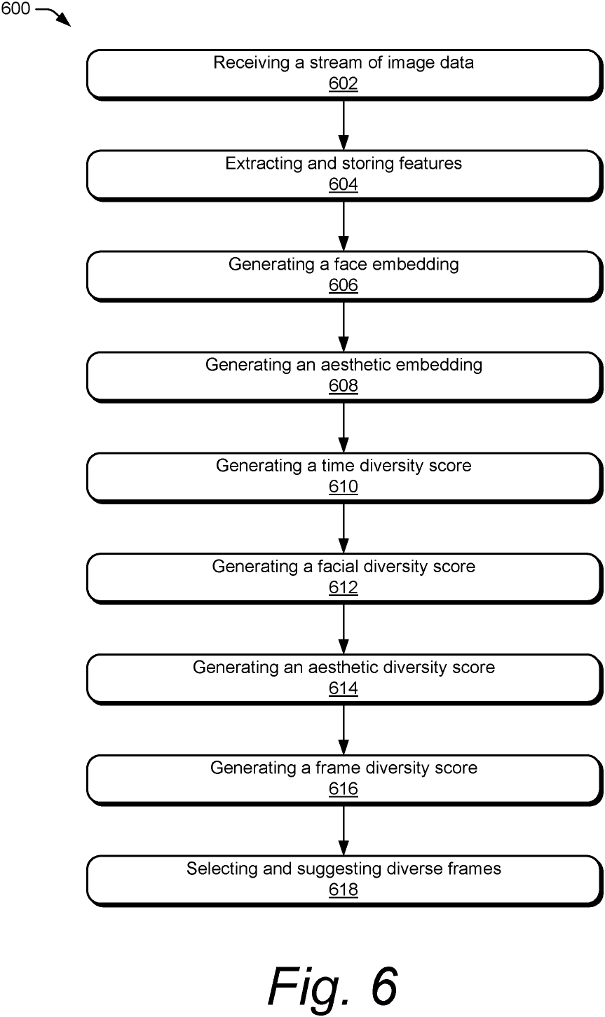

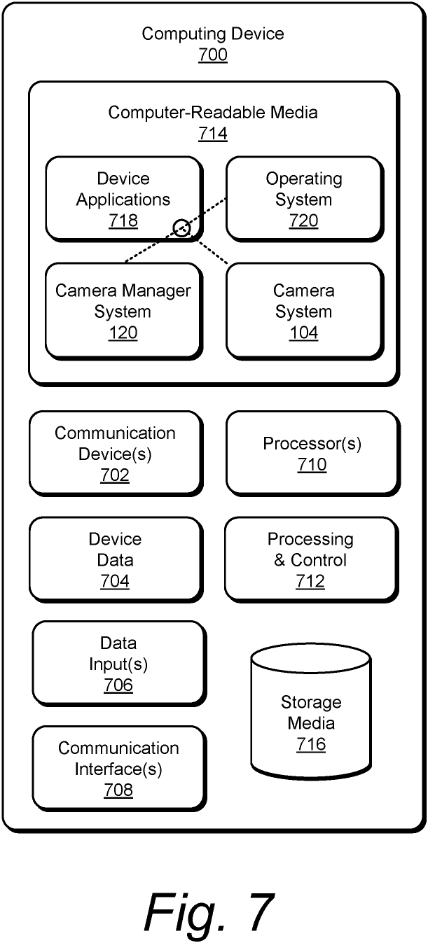

These and other capabilities and configurations, as well as ways in which the entities of FIG. 1 and FIG. 2 act and interact, are set forth in greater detail below. These entities may be further divided, combined, and so on. The environment 100 of FIG. 1, the computing device 102 of FIG. 1 and FIG. 2, and the detailed illustrations of FIG. 2 through FIG. 4 illustrate some of many possible environments and systems capable of employing the described techniques. FIG. 5 and FIG. 6 illustrate some of many possible methods enabling techniques that implement a camera manager system capable of generating frame suggestions from a set of frames. FIG. 7 illustrates aspects of techniques and systems that implement a camera manager system capable of generating frame suggestions from a set of frames in the context of the computing device 102 of FIG. 1 and FIG. 2, but, as noted above, the applicability of the features and advantages of the described techniques and apparatuses are not necessarily so limited, and other implementations involving other types of electronic devices may also be within the scope of the present teachings.

In aspects, image data may be collected by sampling frames from an available camera stream of image data to define a set of frames. For example, a camera application 114 of a computing device 102 may present a live preview based on a stream of image data from an image capture device 106. A plurality of frames defining a set of frames may be sampled from the corresponding live stream of image data. Utilizing the disclosed techniques for generating frame suggestions from a set of frames, a subset of a diverse selection of frames may be saved for later presentation. The camera manager system (camera manager 120) may initiate, without direction from a human user, the capture of a stream of frames by an image capture device 106. Thus, a stream of frames may be obtained even if a live preview is not presented by the camera application 114 to the user 10.

The camera manager 120 may activate responsive to a camera system 104 and/or camera application 114 being launched or becoming active at a computing device 102. The camera manager 120 may also activate responsive to a stream of images becoming available. For example, when a live preview of a camera application 114 is active, the camera manager 120 may activate. Further, the camera manager 120 may activate responsive to user interaction. A user input at a shutter button (e.g., shutter button 116 of the camera application 114, physical shutter button 118) and image data defining a new frame collected (e.g., a shutter frame), for example, may activate the camera manager 120. The camera manager 120 may also deactivate responsive to a second user input. Accordingly, a photo summary may be generated, including content that was missed between the manual capture of two photos. The camera manager 120 may be activated or deactivated, for example, by a dedicated button or user interface (UI) widget.

### Systems

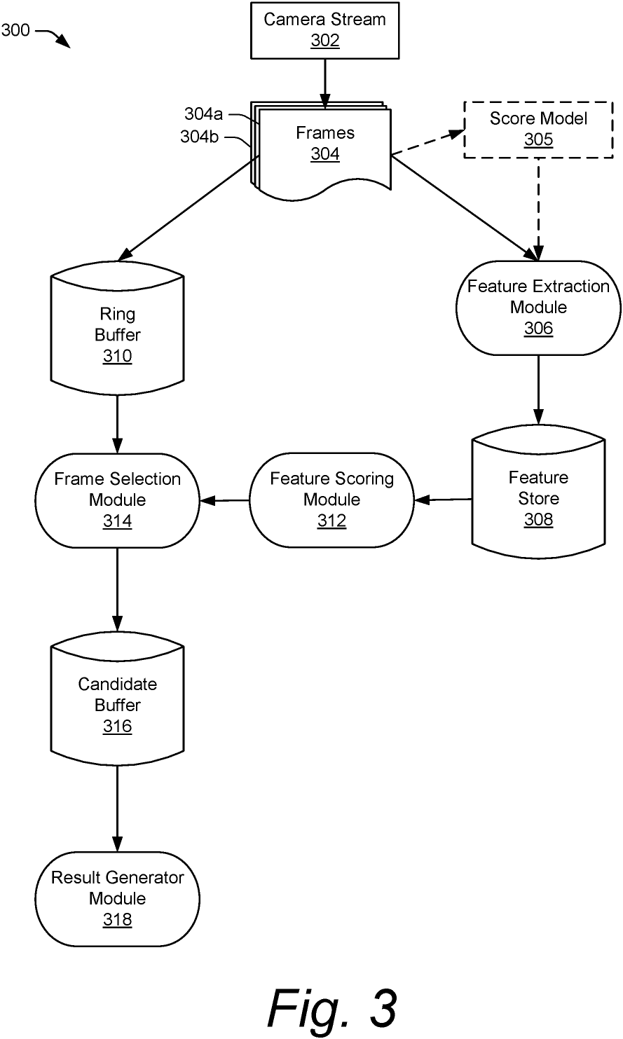

FIG. 3 depicts a block diagram of an architecture 300 utilized in techniques for generating frame suggestions from a set of frames, according to an example implementation. For example, illustrating how components of a camera manager 120 may be integrated with or within a camera application. When the user (e.g., user 10) presses the shutter button (e.g., shutter button 116, shutter button 118) on a computing device (e.g., computing device 102), an image stream (e.g., camera stream 302) is generated.

Image frames 304 (frames 304) may be sampled from an available image stream, for example, a camera stream 302 generated by the camera system 104 of a computing device 102 in a camera preview mode or in a capture mode. Examples of a camera stream 302 include an HD stream (1024×768) and a RAW stream (4032×3024). In a camera preview mode, an application (e.g., camera application 114) may provide a live preview to a user (e.g., user 10), based on the camera stream 302, on a display (e.g., display 108). The frames 304 may include a selected frame 304b and a first frame 304a. In aspects, the first frame 304a is the frame 304 with the most recent timestamp.

The architecture 300 includes at least one machine-learned model trained to receive input data of one or more types (e.g., one or more features associated with an instance or an example) and, in response, provide output data of one or more types (e.g., one or more predictions). For example, one or more score model(s) 305 may subscribe to the camera stream 302 and receive, as an input, image frames 304 from the camera stream 302. The score model 305 may then output a score for the frame. In aspects, the score model 305 is a face quality score model used to calculate and output a face quality score representing the facial features of a frame. The face quality score may be calculated as a weighted linear combination of one or more face attributes (e.g., eyes open, mouth open, frontal gaze, smiling, amusement, contentment, elation, surprise). In aspects, the score model 305 is an aesthetic value score model used to calculate and output an aesthetic value score representing scene-related features of a frame (e.g., non-facial features). The scene-related features may include global spatial information related to aesthetics (e.g., object layouts, blurriness, camera focus). The camera manager system 120 may use a score output by a score model 305 for the frame.

The machine-learned model can be or can include one or more artificial neural networks (also referred to simply as neural networks). A neural network can be organized into one or more layers. For example, an input layer, an output layer, and one or more hidden layers positioned between the input layer and the output layer. One or more neural networks can be used to provide an embedding based on the input data. For example, the embedding can be a representation of knowledge abstracted from the input data into one or more learned dimensions. In some instances, embeddings can be extracted from the output of the network, while in other instances embeddings can be extracted from any hidden node or layer of the network (e.g., a bottleneck layer of the network, a close to final but not final layer of the network). A bottleneck layer contains fewer nodes compared to the previous layers in the model and is utilized to create a constriction in the network that reduces the dimension of embeddings.

The camera manager system 120 may extract embeddings (results) from a bottleneck layer of the score model 305. Such embeddings may include one or more of face expression embeddings (e.g., facial expressions in the frame), face location embeddings (e.g., the locations of faces in the frame), face count embeddings (e.g., the number of faces in the frame), or aesthetic embeddings (e.g., object layout embeddings). The extracted embeddings may capture at least one of global spatial information (e.g., layout) or fine-grained detailed differences (e.g., facial expression changes). The extracted features may include facial features and non-facial features. The extracted embeddings may be output to a feature extraction module 306. A top model targeting diversity measurement can be trained (e.g., through transfer learning) using the extracted embeddings. A feature extraction module 306 may receive one or more of a frame score or extracted embeddings from the score model 305. The extracted embeddings may be utilized by the feature extraction module 306 in feature processing, described below.

The feature extraction module 306 may subscribe to the camera stream 302 and receive, as an input, image frames 304 (e.g., 1027×768 YUV format) from the camera stream 302. The feature extraction module 306 may also receive the corresponding metadata for the frame 304. The feature extraction module 306 may extract features from the frames. The extracted features may include one or more of time features (e.g., timestamps), facial features (e.g., face expressions, face locations, face counts), or aesthetic features (e.g., object layout). In aspects, the feature extraction module 306 may receive one or more of a score or an extracted embedding for a frame (e.g., face quality score, aesthetic value score) from a score model 305.

The feature extraction module 306 performs feature processing on the frames 304 of the camera stream 302 and determines if a frame 304 in the camera stream 302 contains any interesting features (e.g., regions of interest, motion vectors, device motion, face information, frame statistics, visual features, audio features, timestamps). A frame may be characterized as “interesting” (or not) based on the features. The feature extraction module 306 may extract one or more of the features from the score model 305. For example, the feature extraction module 306 may extract face expression features from a score model 305 (e.g., face quality score model) utilized to calculate a face quality score for a frame 304. The feature extraction module 306 may provide the extracted features to a feature store 308.

The feature store 308 receives and stores extracted features from the feature extraction module 306. The extracted features may include one or more extracted embeddings (e.g., face expression embeddings, aesthetic embeddings). The extracted features in the feature store 308 relate to frames 304 stored in a ring buffer 310. The feature store 308 may communicate with, and send features to, a feature scoring module 312. The feature scoring module 312 may perform a feature scoring process that measures one or more metrics (e.g., frame diversity, frame quality) and calculates one or more frame scores (e.g., frame diversity score, frame quality score) from a combination of extracted embeddings of an individual frame, as discussed below.

The ring buffer 310 may also subscribe to the camera stream 302. After a user presses a shutter button (e.g., shutter button 116, shutter button 118), a buffer of candidate frames to suggest is maintained in the ring buffer 310. The ring buffer 310 may store the last n timestamped frames in a first in, first out (FIFO) structure. Because the capacity of the ring buffer 310 is finite, the ring buffer 310 may be continually refreshed with the latest (new) frame replacing the earliest frame in the ring buffer 310. Thus, the ring buffer 310 stores a number of captured frames ranging in time from the newest frame back to the oldest frame, with the number of frames in the ring buffer depending upon the size of the ring buffer 310.

The frame selection module 314 may perform a frame selection process on the set of frames contained in the ring buffer 310. The frame selection process may be performed continuously. The frame selection module 314 represents functionality that receives frames 304 from the ring buffer 310, utilizes at least one frame score (e.g., frame quality score, frame diversity score) received from the feature scoring module 312 to determine which frames in the ring buffer 310 are unnecessary, filters out the unnecessary frames (as judged by the techniques discussed in this document), and provides, as an output, the remaining filtered frames to a candidate buffer 316.

A number of factors may determine when a frame in the ring buffer 310 is deemed unnecessary. In an example, the frame selection module 314 may utilize one or more of a frame diversity score and/or a frame quality score (e.g., from the feature scoring module 312), based on features in the feature store 308, to determine if a frame is unnecessary and should be filtered (evicted) from the ring buffer 310. In some implementations, the frame quality score and/or the frame diversity score may be calculated by the feature scoring module 312 from a combination of extracted embeddings (features) of an individual frame. The frames in the ring buffer 310 may be sorted based on a frame quality score in descending order, and the frames 304 may be iterated through to determine if the quality of a given frame is greater than a quality threshold to determine if the frame should be filtered.

The frame selection module 314 may perform a frame selection process to select at least one frame from the set of frames 304 based on at least one frame score (e.g., frame quality score, frame diversity score) received from the feature scoring module 312. A frame quality score may be calculated by the feature scoring module 312 (e.g., by a frame quality scorer 402 (described below)) or may be calculated by a score model 305. The frame selection module 314 may compare the calculated frame quality score to a quality threshold to determine if the calculated frame quality score exceeds the quality threshold. If the frame selection module 314 determines that the calculated frame quality score for a frame is below a certain threshold, the frame selection module 314 may decide to evict the frame out from the ring buffer 310.

A frame diversity score may be calculated by the feature scoring module 312 (e.g., by a combined frame diversity scorer 410 (described below)). If the frame selection module 314 determines that the calculated frame diversity score for the frame exceeds the quality threshold, the frame selection module 314 may generate a minimal frame diversity score for the frame. The frame selection module 314 may calculate a minimal frame diversity score based on a frame diversity score for the frame with a plurality of frames in the candidate buffer 316 (e.g., all frames in the candidate buffer). The calculated minimal frame diversity score may be tracked by the frame selection module 314. The frame selection module 314 may further compare the minimal frame diversity score to a diversity threshold to determine if the minimal frame diversity score is greater than the diversity threshold (e.g., exceeds a minimal diversity threshold). Responsive to determining that the minimal frame diversity score for the selected frame is greater than the diversity threshold, the selected frame may be stored in the candidate buffer 316 and suggested to the user 10.

The frame selection module 314 further represents functionality that provides input to the candidate buffer 316 to help determine which frames in the candidate buffer 316 should be evicted to ensure that the candidate buffer always contains highlights of the camera stream 302 contents. Unlike the FIFO structure of the ring buffer 310, frames in the candidate buffer 316 are not necessarily dropped in the order of insertion, but according to how important a frame is to the highlights of frames stored in the candidate buffer 316. A number of factors may determine when a frame in the candidate buffer 316 is deemed unnecessary. In an example, the frame selection module 314 may utilize one or more of a frame diversity score or a frame quality score (e.g., from the feature scoring module 312) to determine if a frame is unnecessary and should be evicted from the candidate buffer 316. The frames in the candidate buffer 316 may be sorted based on a frame quality score in descending order, and the frames 304 may be iterated through to determine if the quality of a given frame is greater than a quality threshold to determine if the frame should be filtered.

When the user 10 presses the shutter (e.g., GUI shutter button 116), a candidate buffer 316 containing candidate frames to suggest to the user may be created and maintained. The candidate buffer 316 receives and stores the remaining frames from the frame selection module 314. Because the capacity of the candidate buffer 316 is finite, the frame selection module 314 may determine which frames stored in the candidate buffer 316 to evict from the candidate buffer 316 when capacity is reached. The frame selection module 314 may compare the frame quality score (calculated by the feature scoring module 312) for a frame in the candidate buffer 316 to a quality threshold to determine if the frame quality score for the frame exceeds the quality threshold. If frame quality score for the frame is below a certain threshold, the frame may be evicted out from the candidate buffer 316. If the frame quality score for the frame exceeds the quality threshold, a frame diversity score may be calculated (e.g., by the feature scoring module 312) for the frame with a plurality of frames in the candidate buffer 316 to determine a minimal frame diversity score. The minimal frame diversity score for the frame may be compared to a diversity threshold to determine if the minimal frame diversity score is greater than the diversity threshold. Responsive to determining that the minimal frame diversity score is greater than the diversity threshold, the selected frame may continue to be stored in the candidate buffer 316. If the frame selection module 314 determines that the frame diversity score for a frame is below a certain threshold, the frame selection module 314 may decide to evict the frame out from the candidate buffer 316. By evicting frames from the candidate buffer 316, which are not diverse and/or quality, the frames stored in the candidate buffer 316 better represent how important a frame is to the highlights of the camera stream contents.

When it is determined a user (e.g., user 10 of FIG. 1) is ready to review missed photos, the contents of the candidate buffer 316 may be analyzed and a resulting image object (e.g., an animated .gif, a stack of frames, or collage) highlighting the camera stream 302 may be calculated by a result generator module 318 and, for example, an indication of the image object may be displayed on a display (e.g., display 108).

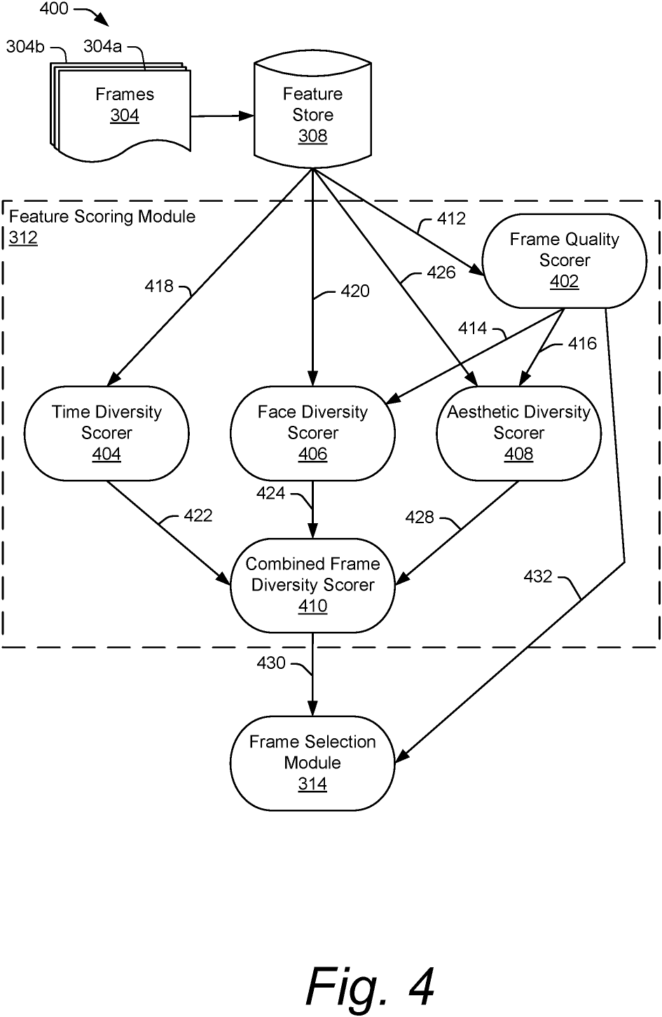

FIG. 4 depicts a block diagram 400 illustrating techniques for calculating at least one frame score (e.g., frame quality score, frame diversity score) for a frame 304 utilizing a frame score generation process according to an example implementation. For example, the components of a camera manager system (camera manager 120) may be integrated with or within a camera application 114, as illustrated in FIG. 3. In the aspects illustrated in FIG. 4, the techniques are performed by a feature scoring module (e.g., feature scoring module 312 of FIG. 3). The feature scoring module is utilized to calculate at least one frame score (e.g., frame diversity score 430, frame quality score 432) for a frame 304, as described herein. The camera manager system 120 may consider a number of signals (e.g., embeddings, features) in calculating a frame score. For example, the camera manager system 120 may use a combination of a time diversity score 422, a facial diversity score 424, and an aesthetic diversity score 428 to compute a frame diversity score 430. The frame diversity score 430 for a frame 304 may be a weighted sum of the time diversity score 422, the facial diversity score 424, and the aesthetic diversity score 428.

As described with respect to FIG. 3, a plurality of frames 304 (e.g., selected frame 304b, first frame 304a) are received, and feature processing is performed (e.g., by a feature extraction module 306) to determine if a frame 304 contains any interesting features (properties) (e.g., regions of interest, motion vectors, device motion, face information, frame statistics). In feature processing, a feature extracting module (e.g., feature extraction module 306 of FIG. 3) extracts features (e.g., embeddings) from a score model and/or from the frames 304. The camera manager system 120 may store the extracted features in a feature store 308. The extracted features may be passed to various classifiers (e.g., frame quality scorer 402, time diversity scorer 404, face diversity scorer 406, aesthetic diversity scorer 408) of a feature scoring module 312 for calculating at least one frame score (e.g., a frame quality score 432, a frame diversity score 430). The output of one or more of the classifiers (e.g., frame quality score 432, time diversity score 422, facial diversity score 424, aesthetic diversity score 428, combined frame diversity scorer 410) may be utilized by the frame selection module 314.

The feature store 308 may pass the extracted features 412 to a frame quality scorer 402 that measures quality metrics. The frame quality scorer 402 may calculate a frame quality score 432 based on the features 412. The frame quality score 432 may be provided as an output to one or more of a frame selection module 314 or a classifier (e.g., face diversity scorer 406, aesthetic diversity scorer 408). The frame quality scorer 402 may generate signals, for example, face expression embeddings, aesthetic embeddings, face location embeddings, face identification embeddings, and face count embeddings. Features associated with at least one face depicted in the frame (e.g., a face location embedding, a face identification embedding, a face count embedding, a face expression embedding, face expression change embedding, face attributes embedding) may be provided by the frame quality scorer 402 to the face diversity scorer 406 as a face embedding 414. The frame quality scorer 402 may provide scene-related (non-facial) features depicted in the frame to the aesthetic diversity scorer 408 as an aesthetic embedding 416.

The feature store 308 may pass time-related features 418 (e.g., timestamps) to the time diversity scorer 404. The time diversity scorer 404 calculates a time diversity score 422 for the frames of the set of frames based on one or more time-related features 418. For example, the time diversity scorer 404 may select a frame of the set of frames, take the timestamps 418 of the selected frame 304b and a first frame 304a as features, and measure the difference between the two timestamps (timestamp difference) to generate (output) a time diversity score 422 for the pair of frames (e.g., for the selected frame 304b relative to the first frame 304a). The time diversity score 422 may be provided to a combined frame diversity scorer 410. In aspects, first frame 304a is the most-recently received frame 304 from the camera stream 302.

Facial-related features capturing, for example, facial expressions, face landmarks, face counts, face locations, etc., may be determined and passed to the face diversity scorer 406. In an example, the facial-related features are facial features 420 passed by the feature store 308 to the face diversity scorer 406. In another example, the facial-related features are face embeddings 414 passed by the frame quality scorer 402 to the face diversity scorer 406. The face diversity scorer 406 may utilize at least one of the facial features 420 or the face embedding 414 in a scoring process to determine at least one facial feature difference between a pair of frames (e.g., the first frame 304a and the selected frame 304b) and calculate a facial diversity score 424 for the selected frame relative to the first frame. In aspects, the face diversity scorer 406 takes features (e.g., facial features 420, face embeddings 414) for the pair of frames and uses a distance metric to generate (output) a facial diversity score 424 for the pair of frames (e.g., for the selected frame relative to the first frame). For example, the face diversity scorer 406 may use a distance metric to calculate a distance between the features of the selected frame 304b and the features of the first frame 304a. The face diversity scorer 406 may provide a facial diversity score 424 to the combined frame diversity scorer 410. The camera manager system 120 may perform the scoring process iteratively on multiple frames of the frames.

Scene-related features capturing object layouts, blurriness, camera focus, and the like may be determined and passed to the aesthetic diversity scorer 408. In an example, the scene-related features are aesthetic features 426 passed by the feature store 308 to the aesthetic diversity scorer 408. In another example, the scene-related features are aesthetic embeddings 416 passed by the frame quality scorer 402 to the aesthetic diversity scorer 408. The aesthetic diversity scorer 408 may utilize at least one of the aesthetic features 426 or the aesthetic embedding 416 in a scoring process to determine an aesthetic feature difference between a pair of frames (e.g., the first frame 304a and the selected frame 304b) and calculate an aesthetic diversity score 428. In aspects, the aesthetic diversity scorer 408 takes features (e.g., aesthetic features 426, aesthetic embeddings 416) for a pair of frames and uses a distance metric to calculate (output) an aesthetic diversity score 428 for the pair of frames (e.g., for the selected frame relative to the first frame). For example, the distance metric may be utilized to calculate a distance between the features of the selected frame 304b and the features of the first frame 304a to output the aesthetic diversity score 428 for the pair of frames. The distance metric used for calculating the aesthetic diversity score may be the same distance metric utilized for calculating the facial diversity score or may be a different distance metric. The aesthetic diversity score measures the aesthetic feature differences between the two frames. The aesthetic diversity score 428 may be provided to the combined frame diversity scorer 410. The camera manager system 120 may perform the scoring process iteratively on multiple frames of the frames. Given two image frames (e.g., selected frame 304b and first frame 304a), a distance metric utilized by a diversity scorer (e.g., the face diversity scorer 406, the aesthetic diversity scorer 408) may be calculated, for example, using one or more of a Euclidean distance metric or a distance metric by machine learning. A distance metric by machine learning may be calculated by collecting a diversity dataset through the crowd compute platform, learning a logistic regression model, and using the probability output as the frame diversity score, naturally scaled to [0, 1].

The combined frame diversity scorer 410 may take the output of one or more of the classifiers (e.g., time diversity score 422, facial diversity score 424, aesthetic diversity score 428) and calculate a frame diversity score 430. The frame diversity score 430 may be utilized by a frame selection module (e.g., frame selection module 314 of FIG. 3) in a frame selection process, as described above with respect to FIG. 3. In an example, the frame diversity score is utilized by a frame selection module to determine whether to move a frame (e.g., selected frame 304b, first frame 304a) from the ring buffer to the candidate buffer 316. In another example, the frame diversity score is utilized by a frame selection module to select frames in a ring buffer 310 to maintain in the ring buffer and/or to select frames to evict from the ring buffer 310. In an additional example, the frame diversity score is utilized by a frame selection module to select frames stored in a candidate buffer 316 to include as part of an image object generated by a result generator module 318 representing highlights of the camera stream 302.

In a frame score generation process, frame quality scores (e.g., frame quality score 432) for frames in the ring buffer 310 are determined and frame diversity scores with frames in the candidate buffer 316 (e.g., frame diversity score 430) for frames in the ring buffer 310 are determined. Frames in the ring buffer 310 determined to have a high quality score, and a high diversity score with frames in the candidate buffer 316 may be added to the candidate buffer 316 and evicted from the ring buffer 310. By discarding the unnecessary frames, the camera manager system 120 frees up space in the ring buffer 310, leaving only the “best” frames captured over a time period (e.g., the past three seconds).

In another example, the frame diversity score 430 may be utilized by a frame selection module (e.g., frame selection module 314 of FIG. 3) in a frame selection process, as described above with respect to FIG. 3, to maintain the candidate frames in the ring buffer 310 when a new frame (e.g., first frame 304a) is received by the ring buffer 310. The combined frame diversity scorer 410 may compute the frame diversity score 430 for the first frame 304a with all the frames in the ring buffer 310 (frames already selected by the selection process). The combined frame diversity scorer 410 may utilize the frame diversity score 430 in a filtering process to filter (e.g., evict) one or more frames from the ring buffer 310. The camera manager system 120 may perform the filtering process iteratively on multiple frames of the frames. In an example filtering process, iteratively on multiple frames of the stored frames, a frame is selected from the stored frames, a frame quality score for the selected frame is calculated, and a drop score is assigned to the selected frame. The drop score may be a weighted linear combination of the frame quality score 432 and the frame diversity score 430 for the selected frame. After assigning drop scores, the camera manager system 120 may filter frames. For example, the frame with the lowest drop score can be determined, for example, by sorting the frames in the ring buffer 310 in an order of descending drop score to determine the frame in the ring buffer 310 having the lowest (minimal) drop score. The camera manager system 120 could then replace the stored frame in the ring buffer 310 having the lowest drop score with the new frame (e.g., first frame 304a).

In a frame filtering process, if the frame selection module 314 determines that the calculated frame quality score for a selected frame in the ring buffer 310 exceeds the quality threshold, the frame selection module 314 may calculate a second frame diversity score for the selected ring buffer frame, for example, calculated based on frame diversity for the selected ring buffer frame with, iteratively, a plurality of frames in the candidate buffer 316 (e.g., all frames in the candidate buffer). The second frame diversity score used to determine the minimal (e.g., lowest) diversity score between the selected ring buffer frame and frames in the candidate buffer 316. The frame selection module 314 may further compare the minimal diversity score to a diversity threshold to determine if the minimal diversity score is greater than the diversity threshold (e.g., exceeds a minimal diversity threshold). Responsive to determining that the minimal diversity score for the selected ring buffer frame is greater than the diversity threshold, the selected ring buffer frame may be stored in the candidate buffer 316 to include as part of an image object generated by a result generator module 318 representing highlights of the camera stream 302. In an example, the camera manager system 120 may move the selected ring buffer frame from the ring buffer 310 to the candidate buffer 316. In another example, the camera manager system 120 copies the selected ring buffer frame to the candidate buffer 316 and evicts the copy of the frame from the ring buffer 310.

In aspects, a maximal individual score (e.g., one of the time diversity score 422, the facial diversity score 424, or the aesthetic diversity score 428) may be used by the camera manager system 120 as the frame diversity score 430. In another aspects (not illustrated), embeddings (e.g., face expression embeddings, aesthetic embeddings, face count embeddings) generated by the frame quality scorer 402 may be wrapped as a diversity scorer frame and sent to the combined frame diversity scorer 410 to compute the frame diversity score 430.

Throughout this disclosure, examples are described where a computing device (e.g., the computing device 102) may analyze information (e.g., image data) associated with a user, for example, facial features extracted by the feature extraction module 306 and stored in the feature store 308. The computing device, however, can be configured to only use the information after the computing device receives explicit permission from the user of the computing device to use the data. For example, in situations where the computing device 102 analyzes image data for facial features to generate frame suggestions from a set of frames, individual users may be provided with an opportunity to provide input to control whether programs or features of the computing device 102 can collect and make use of the data. The individual users may have constant control over what programs can or cannot do with image data. In addition, information collected may be pretreated in one or more ways before it is transferred, stored, or otherwise used, so that personally-identifiable information is removed. For example, before the computing device 102 shares image data with another device (e.g., to train a model executing at another computing device), the computing device 102 may pre-treat the image data to ensure that any user-identifying information or device-identifying information embedded in the data is removed. Thus, the user may have control over whether information is collected about the user and the user’s device, and how such information, if collected, may be used by the computing device and/or a remote computing system.

The entities of FIG. 1, FIG. 2, FIG. 3, and FIG. 4 may be further divided, combined, used along with other components, and so on. In this way, different implementations of the computing device 102, with different configurations of the camera system 104 and the camera manager 120, can be used to implement techniques and apparatuses that implement camera manager systems capable of generating frame suggestions from a set of frames. The example operating environment 100 of FIG. 1 and the detailed illustrations of FIG. 2, FIG. 3, FIG. 4, FIG. 5, FIG. 6, and FIG. 7 illustrate but some of many possible environments and systems capable of employing the described techniques and apparatuses that implement camera manager systems capable of generating frame suggestions from a set of frames.

### Example Methods

This section describes example methods, which may operate separately or together in whole or in part. Various example methods are described, each set forth in a subsection for ease of reading; these subsection titles are not intended to limit the interoperability of each of these methods one with the other.

FIG. 5 illustrates an example method 500, performed by a computing device, for generating frame suggestions from a set of frames. The method 500 is illustrated as a set of blocks that specify operations performed, but are not necessarily limited, to the order or combinations illustrated for performing the operations by the respective blocks. Further, any of one or more of the operations may be repeated, combined, reorganized, or linked to provide a wide array of additional and/or alternate methods (e.g., method 600). In portions of the following discussion, reference may be made to the example operating environment 100 of FIG. 1 or to entities or processes as detailed in other Figures, reference to which is made for example only. The techniques are not limited to performance by one entity or multiple entities operating on one device.

At 502, the computing device (e.g., computing device 102) receives a stream of image data defining a set of frames (e.g., frames 304) and a first frame (e.g., frame 304a). The image data may be received from a camera system (e.g., camera system 104) of the computing device. The set of frames may include a selected frame (e.g., selected frame 304b). The computing device initiates, at 504, a frame score generation process to calculate a frame diversity score based on features extracted from the frames. In the frame score generation process, the computing device, at 506, calculates a time diversity score for the frames of the set of frames relative to the first frame, at 508, calculates a facial diversity score for the frames of the set of frames relative to the first frame, and at 510, calculates an aesthetic diversity score for the frames of the set of frames relative to the first frame. The computing device then, at 512, calculates a frame diversity score for the frames of the set of frames relative to the first frame based on the facial diversity score, the aesthetic diversity score, and the time diversity score (e.g., by combining the facial diversity score, the aesthetic diversity score, and the time diversity score). Using the frame diversity score, at 514, the computing device determines whether to include the first frame as part of an image object (e.g., generated by a result generator module 318) representing suggested frames (highlights) of the stream of image data.

FIG. 6 illustrates another example method 600, performed by a computing device, for calculating a frame score for a frame, for example, by the feature scoring module 312 of FIG. 3 and FIG. 4. At 602, the computing device (e.g., computing device 102) receives a stream of image data defining a set of frames (e.g., frames 304) and a first frame (e.g., frame 304a), for example, from a camera system (e.g., camera system 104) of the computing device. At 604, the computing device extracts features from the frames and the first frame and stores the extracted features (embeddings) in a feature store (e.g., feature store 308). A feature scoring module implemented on the computing device receives features from the feature store. The feature scoring module includes one or more classifiers (e.g., a frame quality scorer, a time diversity scorer, a face diversity scorer, an aesthetic diversity scorer) that receive features from the feature store. At 606, the frame quality scorer generates a face embedding depicting features associated with at least one face depicted in a frame. At 608, the frame quality scorer generates an aesthetic embedding depicting scene-related (non-facial) features depicted in the frame. At 610, the time diversity scorer generates a time diversity score utilizing time-related features. The face diversity scorer generates a facial diversity score utilizing at least one of facial features or face embeddings at 612. The aesthetic diversity scorer, at 614, generates an aesthetic diversity score utilizing at least one of aesthetic features or aesthetic embeddings. At 616, a frame diversity score is generated based on the time diversity score, the facial diversity score, and the aesthetic diversity score (e.g., by combining the facial diversity score, the aesthetic diversity score, and the time diversity score). The frame diversity score is used by the computing device, at 618, to select and suggest diverse frames from a set of frames.

### Example Computing Device

FIG. 7 illustrates various components of an example computing device 700 (device 700) that can be implemented as any type of client, server, and/or computing device as described with reference to the previous Figures to implement techniques and apparatuses that implement camera manager systems capable of generating frame suggestions from a set of frames.

The device 700 includes communication devices 702 that enable wired and/or wireless communication of device data 704 (e.g., received data, data that is being received, data scheduled for broadcast, data packets of the data). The device data 704 or other device content can include configuration settings of the device, media content stored on the device, and/or information associated with a user of the device. Media content stored on the device 700 can include any type of audio, video, and/or image data. The device 700 includes one or more data inputs 706 via which any type of data, media content, and/or inputs can be received, including user-selectable inputs (explicit or implicit), messages, music, television media content, recorded video content, and any other type of audio, video, and/or image data received from any content and/or data source.

The device 700 also includes communication interfaces 708, which can be implemented as any one or more of a serial and/or parallel interface, a wireless interface, any type of network interface, a modem, and as any other type of communication interface. The communication interfaces 708 provide a connection and/or communication links between the device 700 and a communication network by which other electronic, computing, and communication devices communicate data with the device 700.

The device 700 includes one or more processors 710 (e.g., any of microprocessors, controllers, and the like), which process various computer-executable instructions to control the operation of the device 700 and to enable techniques for camera manager systems capable of generating frame suggestions from a set of frames. Alternatively or in addition, the device 700 can be implemented with any one or combination of hardware, firmware, or fixed logic circuitry that is implemented in connection with processing and control circuits, which are generally identified at 712. Although not illustrated, the device 700 can include a system bus or data transfer system that couples the various components within the device. A system bus can include any one or combination of different bus structures, including a memory bus or memory controller, a peripheral bus, a universal serial bus, and/or a processor or local bus that utilizes any of a variety of bus architectures.

The device 700 also includes a computer-readable media 714 (CRM 714), including one or more memory devices that enable persistent and/or non-transitory data storage, in contrast to mere signal transmission, examples of which include random access memory (RAM), non-volatile memory (e.g., any one or more of a read-only memory (ROM), flash memory, EPROM, EEPROM), and a disk storage device. A disk storage device may be implemented as any type of magnetic or optical storage device, for example, a hard disk drive, a recordable and/or rewriteable compact disc (CD), any type of a digital versatile disc (DVD), and the like. The device 700 can also include a mass storage media device (storage media) 716. The CRM 714 provides data storage mechanisms to store the device data 704, as well as various device applications 718 and any other types of information and/or data related to operational aspects of the device 700. For example, an operating system 720 can be maintained as a computer application with the CRM 714 and executed on the processor(s) 710. The device applications 718 may include a device manager, for example, any form of a control application, software application, signal-processing and control module, code that is native to a particular device, a hardware abstraction layer for a particular device, and so on. The device applications 718 also include any system components, engines, or managers to implement camera manager systems capable of generating frame suggestions from a set of frames. In this example, device applications 718 include the camera manager system 120 and the camera system 104.

The techniques and apparatuses include non-transitory computer-readable storage media having instructions stored thereon that, responsive to execution by one or more computer processors, perform the methods set forth herein, as well as systems and means for performing these methods.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

### EXAMPLES

In the following section, examples are provided.

Example 1: A method (500) performed by a computing device (102) comprising: receiving (502) a stream of image data defining a first frame (304a) and a set of frames (304) not including the first frame; performing (504) a frame score generation process to calculate a frame diversity score (430), the frame score generation process comprising: calculating (506) a time diversity score (422) for frames of the set of frames relative to the first frame; calculating (508) a facial diversity score (424) for the frames of the set of frames relative to the first frame; calculating (510) an aesthetic diversity score (428) for the frames of the set of frames relative to the first frame; and calculating (512) the frame diversity score (430) for the frames of the set of frames relative to the first frame based on the facial diversity score, the aesthetic diversity score, and the time diversity score; and determining (514), using the frame diversity score, whether to include the first frame as part of an image object representing suggested frames of the stream of image data.

Example 2: The method of Example 1, wherein determining, using the frame diversity score, whether to include the first frame as part of an image object representing suggested frames of the stream of image data further comprises: storing, in a ring buffer (310), the set of frames (304); iteratively performing, for each stored frame, a filtering process comprising: selecting a frame from the stored frames; calculating a frame quality score for the selected frame; assigning a drop score to the selected frame; determining the stored frame with a lowest drop score; evicting the stored frame with the lowest drop score from the ring buffer; and storing, in the ring buffer, the first frame.

Example 3: The method of Example 2, wherein the filtering process further comprises: determining whether the calculated frame quality score of the selected frame is greater than a quality threshold; responsive to determining that the calculated frame quality score is greater than the quality threshold, calculating a minimal diversity score for the selected frame relative to candidate frames stored in a candidate buffer; determining if the minimal diversity score exceeds a minimal diversity threshold; and responsive to determining that the minimal diversity score exceeds the minimal diversity threshold, adding the selected frame to the candidate buffer.

Example 4: The method of Example 2 or Example 3, wherein calculating the frame quality score for the selected frame comprises: determining extracted facial features for the selected frame; determining extracted aesthetic features for the selected frame; and using the extracted facial features and the extracted aesthetic features to calculate the frame quality score.

Example 5: The method of Example 2, Example 3, or Example 4, wherein the drop score comprises: a weighted linear combination of the frame quality score (432) and the frame diversity score (430) for the selected frame.

Example 6: The method of any preceding Example, wherein calculating the facial diversity score for the frames of the set of frames relative to the first frame comprises: determining facial-related features (414, 420) for the first frame (304a); and iteratively performing a scoring process comprising: selecting a frame (304b) from the set of frames (304); determining facial-related features for the selected frame; and utilizing a distance metric to determine a facial feature difference between the facial-related features of the selected frame and the facial-related features of the first frame.

Example 7: The method of Example 6, wherein calculating the facial diversity score for the frames of the set of frames relative to the first frame further comprises: extracting facial features from the selected frame and from the first frame, the extracted facial features representing at least one of facial features depicted in the frames or face embeddings; and determining a facial feature difference between the selected frame and the first frame utilizing the extracted facial features and the distance metric.

Example 8: The method of Example 7, wherein determining a facial feature difference between the selected frame and the first frame utilizing the facial features and the distance metric comprises: calculating a distance between the extracted facial features of the selected frame and the extracted facial features of the first frame; and utilizing the calculated distance to calculate a facial diversity score for the selected frame, the facial diversity score representing the facial diversity between the selected frame and the first frame.

Example 9: The method of any preceding Example, wherein calculating the aesthetic diversity score for the frames of the set of frames relative to the first frame comprises: determining scene-related features (416, 426) for the first frame; and iteratively performing a scoring process comprising: selecting a frame from the set of frames; extracting scene-related features from the selected frame; and utilizing a distance metric to determine an aesthetic feature difference between the scene-related features of the selected frame and the scene-related features of the first frame.

Example 10: The method of Example 9, further comprising: extracting the scene-related features from the selected frame and from the first frame, the extracted scene-related features representing at least one of aesthetic features depicted in the frames or aesthetic embeddings.

Example 11: The method of Example 10, wherein utilizing a distance metric to determine an aesthetic feature difference between the scene-related features of the selected frame and the scene-related features of the first frame comprises: calculating a distance between the extracted scene-related features of the selected frame and the extracted scene-related features of the first frame; and utilizing the calculated distance to calculate an aesthetic diversity score for the selected frame, the aesthetic diversity score representing the aesthetic diversity between the selected frame and the first frame.

Example 12: The method of any preceding Example, wherein calculating the frame diversity score for the frames of the set of frames relative to the first frame based on the facial diversity score, the aesthetic diversity score, and the time diversity score comprises: computing a weighted sum of the facial diversity score, the aesthetic diversity score, and the time diversity score.

Example 13: The method of any preceding Example, wherein calculating the time diversity score for the frames of the set of frames relative to the first frame comprises: determining a timestamp difference between a selected frame of the set of frames and the first frame; and generating the time diversity score based on the determined timestamp difference.

Example 14: The method of any preceding Example, further comprising: outputting, for display at a display device (108) to a user, an indication of the image object.

Example 15: An apparatus comprising: a camera manager system (120) configured to generate frame suggestions from a set of frames (304); and a processor (11) and memory system (112), coupled with the camera manager system (120), configured to perform a method of any of Examples 1 through 14.

Example 16: A computer-readable storage medium having computer-readable instructions stored thereon that, responsive to execution by one or more computer processors, cause the one or more processors to perform a method according to any of Examples 1 to 14.

### Conclusion

Although implementations of techniques for, and apparatuses enabling, camera manager systems capable of generating frame suggestions from a set of frames have been described in language specific to features and/or methods, it is to be understood that the subject of the appended claims is not necessarily limited to the specific features or methods described. Rather, the specific features and methods are disclosed as example implementations enabling techniques for generating frame suggestions from a set of frames.

What is claimed is:

1. A method (500) performed by a computing device (102) comprising:
receiving (502) a stream of image data defining a first frame (304a) and a set of frames (304) not including the first frame;
performing (504) a frame score generation process to calculate a frame diversity score (430), the frame score generation process comprising:
calculating (506) a time diversity score (422) for frames of the set of frames relative to the first frame;
calculating (508) a facial diversity score (424) for the frames of the set of frames relative to the first frame;
calculating (510) an aesthetic diversity score (428) for the frames of the set of frames relative to the first frame; and
calculating (512) the frame diversity score (430) for the frames of the set of frames relative to the first frame based on the facial diversity score, the aesthetic diversity score, and the time diversity score; and
determining (514), using the frame diversity score, whether to include the first frame as part of an image object representing suggested frames of the stream of image data.

2. The method of claim 1, wherein determining, using the frame diversity score, whether to include the first frame as part of an image object representing suggested frames of the stream of image data further comprises:
storing, in a ring buffer (310), the set of frames;
iteratively performing, for each stored frame, a filtering process comprising:
selecting a frame from the stored frames;
calculating a frame quality score (432) for the selected frame;
assigning a drop score to the selected frame;
determining the stored frame with a lowest drop score;
evicting the stored frame with the lowest drop score from the ring buffer; and
storing, in the ring buffer, the first frame.

3. The method of claim 2, wherein the filtering process further comprises:
selecting a frame stored in the ring buffer;
determining whether the calculated frame quality score of the selected ring buffer frame is greater than a quality threshold;
responsive to determining that the calculated frame quality score is greater than the quality threshold, calculating a minimal diversity score for the selected ring buffer frame relative to candidate frames stored in a candidate buffer (316);
determining if the minimal diversity score exceeds a minimal diversity threshold; and
responsive to determining that the minimal diversity score exceeds the minimal diversity threshold, adding the selected ring buffer frame to the candidate buffer.

4. The method of claim 2, wherein calculating the frame quality score for the selected frame comprises:
determining extracted facial features for the selected frame;
determining extracted aesthetic features for the selected frame; and
using the extracted facial features and the extracted aesthetic features to calculate the frame quality score.

5. The method of claim 2, wherein the drop score comprises:
a weighted linear combination of the frame quality score (432) and the frame diversity score (430) for the selected frame.

6. The method of claim 1, wherein calculating the facial diversity score for the frames of the set of frames relative to the first frame comprises:
determining facial-related features (414, 420) for the first frame (304a); and
iteratively performing a scoring process comprising:
selecting a frame (304b) from the set of frames (304);
determining facial-related features for the selected frame; and
utilizing a distance metric to determine a facial feature difference between the facial-related features of the selected frame and the facial-related features of the first frame.

7. The method of claim 6, wherein calculating the facial diversity score for the frames of the set of frames relative to the first frame further comprises:
extracting facial features from the selected frame and from the first frame, the extracted facial features representing at least one of facial features depicted in the frames or face embeddings; and
determining a facial feature difference between the selected frame and the first frame utilizing the extracted facial features and the distance metric.

8. The method of claim 7, wherein determining a facial feature difference between the selected frame and the first frame utilizing the facial features and the distance metric comprises:
calculating a distance between the extracted facial features of the selected frame and the extracted facial features of the first frame; and
utilizing the calculated distance to calculate a facial diversity score for the selected frame, the facial diversity score representing the facial diversity between the selected frame and the first frame.

9. The method of claim 1, wherein calculating the aesthetic diversity score for the frames of the set of frames relative to the first frame comprises:
determining scene-related features (416, 426) for the first frame; and
iteratively performing a scoring process comprising:
selecting a frame from the set of frames;
extracting scene-related features from the selected frame; and
utilizing a distance metric to determine an aesthetic feature difference between the scene-related features of the selected frame and the scene-related features of the first frame.

10. The method of claim 9, further comprising:
extracting the scene-related features from the selected frame and from the first frame, the extracted scene-related features representing at least one of aesthetic features depicted in the frames or aesthetic embeddings.

11. The method of claim 10, wherein utilizing a distance metric to determine an aesthetic feature difference between the scene-related features of the selected frame and the scene-related features of the first frame comprises:
calculating a distance between the extracted scene-related features of the selected frame and the extracted scene-related features of the first frame; and
utilizing the calculated distance to calculate an aesthetic diversity score for the selected frame, the aesthetic diversity score representing the aesthetic diversity between the selected frame and the first frame.

12. The method of claim 1, wherein calculating the frame diversity score for the frames of the set of frames relative to the first frame based on the facial diversity score, the aesthetic diversity score, and the time diversity score comprises:
computing a weighted sum of the facial diversity score, the aesthetic diversity score, and the time diversity score.

13. The method of claim 1, wherein calculating the time diversity score for the frames of the set of frames relative to the first frame comprises:
determining a timestamp difference between a selected frame of the set of frames and the first frame; and
generating the time diversity score based on the determined timestamp difference.

14. The method of claim 1, further comprising:
outputting, for display at a display device (108) to a user, an indication of the image object.

15. An apparatus comprising:
a camera manager system (120) configured to generate frame suggestions from a set of frames (304); and
a processor (11) and memory system (112), coupled with the camera manager system (120), configured to:
receive (502) a stream of image data defining a first frame (304a) and a set of frames (304) not including the first frame;
perform (504) a frame score generation process to calculate a frame diversity score (430), the frame score generation process comprising:
calculating (506) a time diversity score (422) for frames of the set of frames relative to the first frame;
calculating (508) a facial diversity score (424) for the frames of the set of frames relative to the first frame;
calculating (510) an aesthetic diversity score (428) for the frames of the set of frames relative to the first frame; and
calculating (512) the frame diversity score (430) for the frames of the set of frames relative to the first frame based on the facial diversity score, the aesthetic diversity score, and the time diversity score; and
determine (514), using the frame diversity score, whether to include the first frame as part of an image object representing suggested frames of the stream of image data.

16. A computer-readable storage medium having computer-readable instructions stored thereon that, responsive to execution by one or more computer processors, cause the one or more processors to:
receive (502) a stream of image data defining a first frame (304a) and a set of frames (304) not including the first frame;
perform (504) a frame score generation process to calculate a frame diversity score (430), the frame score generation process comprising:
calculating (506) a time diversity score (422) for frames of the set of frames relative to the first frame;
calculating (508) a facial diversity score (424) for the frames of the set of frames relative to the first frame;
calculating (510) an aesthetic diversity score (428) for the frames of the set of frames relative to the first frame; and
calculating (512) the frame diversity score (430) for the frames of the set of frames relative to the first frame based on the facial diversity score, the aesthetic diversity score, and the time diversity score; and
determine (514), using the frame diversity score, whether to include the first frame as part of an image object representing suggested frames of the stream of image data.
